(19) United States
(12) Patent Application Publication
(10) Pub. No.: US 2021/0001934 A1
(43) Pub. Date: Jan. 7, 2021

(54) CRAWLED VEHICLE FOR THE PREPARATION OF SKI PISTES

(71) Applicant: Prinoth S.P.A., Vipiteno (IT)

(72) Inventors: Karl Leitner, Vipiteno (IT); Gregor Maurer, Vipiteno (IT)

(21) Appl. No.: 16/976,956

(22) PCT Filed: Mar. 1, 2019
(86) PCT No.: PCT/IB2019/051676

§ 371 Date: Aug. 31, 2020

(30) Foreign Application Priority Data
Mar. 2, 2018 (IT) 102018000003244

(51) Int. Cl. B62D 55/108; B62D 55/112; B62D 55/06; B62D 55/116

(52) U.S. Cl. CPC B62D 55/108; B62D 55/1125; B62D 55/116; B60G 2300/32; B62D 55/06

(57) ABSTRACT

Crawled vehicle for the preparation of ski pistes; the crawled vehicle comprising a frame; two wheels assemblies displaced at opposite side with respect to the frame; two crawls, each of them wounded respectively around to one of the two wheels assemblies; and at least one supporting device, for each wheels assemblies, coupled to at least two wheels of the wheel assembly and connected in an articulated jointed manner to the frame for coupling the at least two wheels of the wheels assembly to the frame; wherein the supporting device has a first supporting element, which supports one of the at least two wheels of the wheels assembly; and a second supporting element, which supports another of the two wheels of the wheels assembly; and wherein the first supporting element and the second supporting element are connected to one another through a first articulated joint in a first point.

### PRIORITY CLAIM

This application is a national stage application of PCT/IB2019/051676, filed on Mar. 1, 2019, which claims the benefit of and priority to Italian Patent Application No. 102018000003244, filed on Mar. 2, 2018, the entire contents of which are each incorporated by reference herein.

### TECHNICAL FIELD

The present disclosure relates to a crawled vehicle for the preparation of ski pistes.

In particular, the present disclosure relates to a crawled vehicle comprising a frame; two wheel assemblies arranged on opposite sides of the frame; two crawls arranged around the respective wheel assemblies; and at least one supporting device for each wheel assembly, which is coupled to at least two wheels of the wheel assembly and is connected to the frame so as to couple said at least two wheels of the wheel assembly to the frame.

### BACKGROUND

Certain drawbacks of certain of the prior art lies in the fact that said crawled vehicle has undesired vibrations.

### SUMMARY

An object of the present disclosure is to provide a crawled vehicle which is capable of reducing certain of the drawbacks of certain of the prior art.

According to the present disclosure, there is provided a crawled vehicle for the preparation of ski pistes; the crawled vehicle comprising:
a frame;
two wheel assemblies arranged on opposite sides of the frame;
two crawls, each of them respectively wounded around one of the two wheel assemblies;
at least one supporting device for each wheel assembly, which is coupled to at least two wheels of the wheel assembly and is connected in an articulated manner to the frame so as to couple said at least two wheels of the wheel assembly to the frame; wherein the supporting device has a first supporting element, which supports one of said at least two wheels of the wheel assembly; and a second supporting element, which supports another one of the two wheels of the wheel assembly; and wherein the first supporting element and the second supporting element are connected to one another in an elastically flexible manner or through a first articulated joint in a first point; wherein in certain embodiments, the first articulated joint is a hinge.

It should be appreciated that in accordance with the present disclosure, the two wheels of the wheel assembly are connected to one another through the supporting device, so as to have at least one degree of freedom of movement relative to one another, which reduces the vibrations transmitted to the frame.

According to certain embodiments, the first supporting element and the second supporting element are connected to one another through an elastic structure, in particular a leaf spring, a fibreglass structure or a carbon structure.

According to certain embodiments, the supporting device comprises an elastic structure, in particular a leaf spring, a fibreglass structure or a carbon structure; the first supporting element and the second supporting element, in particular the first supporting element and the second supporting element are defined by respective portions or by respective ends of the elastic structure, in particular by respective portions or ends of the leaf spring or fibreglass structure or carbon structure.

According to certain embodiments, the supporting device comprises a further articulated joint to couple the first supporting element to the second supporting element in an articulated manner, said further articulated joint is, in certain embodiments, a hinge.

According to another embodiment, the first and the second supporting element are connected to one another through a shock absorber, in particular in a second point different from the first point.

According to different embodiments, the shock absorber has a variable stiffness and/or a variable geometry.

According to different embodiments, the shock absorber is mechanical and/or hydraulic and/or electromagnetic and/or an air suspension or any combination thereof.

According to another embodiment, the supporting device comprises a connection articulated joint coupled to the frame in order to couple the supporting device to the frame in an articulated manner; the articulated connection joint is, in certain embodiments, a hinge.

According to different embodiments, the connection articulated joint is partly housed on the first and/or on the second supporting element.

According to another embodiment, said at least two wheels of the wheel assembly are supporting wheel in particular free rotating wheel.

According to another embodiment, the wheel assembly comprises a driving wheel, such as a rear wheel.

According to another embodiment, the wheel assembly comprises a crawl regulating wheel, such as a front wheel, having a mobile position with respect to the frame so as to stretch the crawl.

According to another embodiment, said at least two wheels are middle wheels between the crawl regulating wheel and the driving wheel and, in certain embodiments, are free rotating wheels.

According to another embodiment, the supporting device is connected to the frame through a shock absorber assembly.

According to different embodiments, the shock absorber assembly has a variable stiffness and/or a variable geometry.

According to another embodiment, the shock absorber assembly comprises a double-acting hydraulic cylinder.

According to different embodiments, the shock absorber assembly is mechanical and/or hydraulic and/or electromagnetic and/or an air suspension or any combination thereof.

According to another embodiment, each wheel assembly comprises a crawl regulating wheel, such as a front wheel, a driving wheel, such as a rear wheel, two pairs of supporting wheels and two supporting devices, each coupled to one respective pair of supporting wheels.

### BRIEF DESCRIPTION OF THE DRAWINGS

Other features and advantages of the present disclosure will be best understood upon perusal of the following description of a non-limiting embodiment thereof, with reference to the accompanying drawing, wherein:

FIG. 1 is a side elevation view, with parts removed for greater clarity, of a crawled vehicle according to the present disclosure;

FIG. 2 is a side elevation view of a detail of the crawled vehicle of FIG. 1;

FIG. 3 is a perspective view of a detail of the crawled vehicle according to an embodiment of the present disclosure;

FIG. 4 is a schematic view from the top, with parts removed for greater clarity, of the crawled vehicle of FIG. 1; and

FIG. 5 is a side elevation view of a detail of an alternative embodiment of the crawled vehicle.

### DETAILED DESCRIPTION

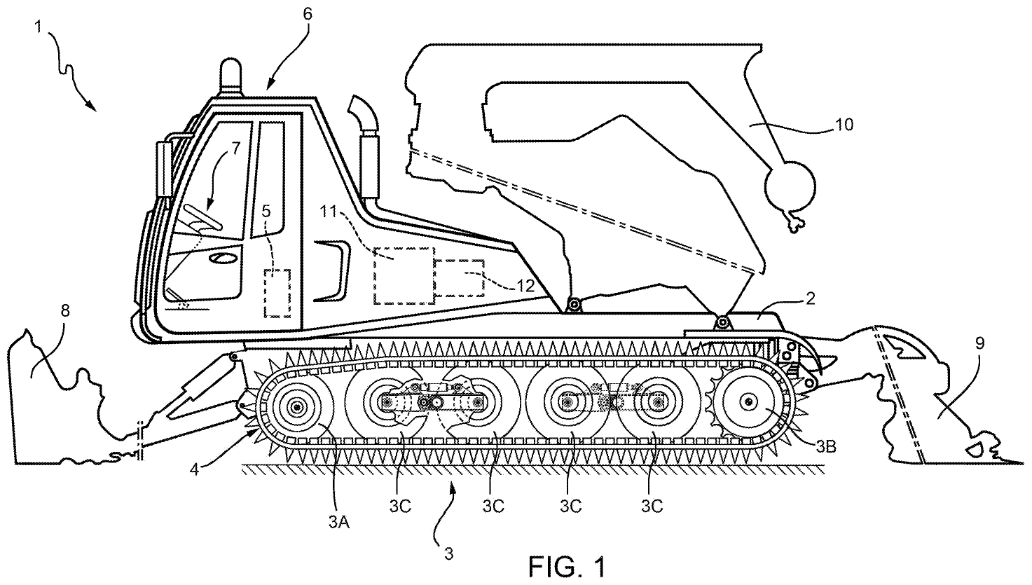

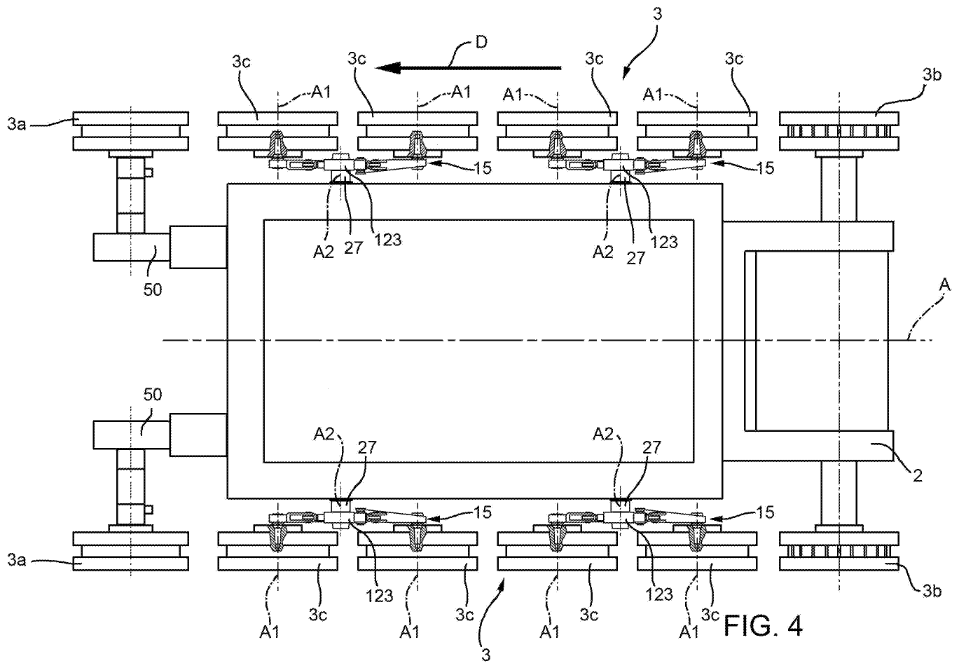

With reference to FIG. 1, number 1 defines, as a whole, a crawled vehicle, in particular a crawled vehicle for the preparation of ski pistes, configured to be moved in a moving direction D (FIG. 4).

With reference to FIG. 1, the crawled vehicle 1 comprises a frame 2; two wheel assemblies 3 (only one of them is shown in FIG. 1) with a variable configuration and arranged on opposite sides of the frame 2; and two crawls 4, each wound around one of the two respective wheel assemblies 3.

With reference to FIGS. 1 and 4, the frame 2 extends along an axis A and supports the wheel assemblies 3.

Each wheel assembly 3 comprises a front wheel 3a, a rear wheel 3b and four central wheels 3c arranged between the front wheel 3a and the rear wheel 3b. The wheel 3b is a driving wheel.

With reference to FIG. 4, each front wheel 3a is connected to the frame 2 by a carriage 50, which is coupled to the frame 2 so that it can slide along the direction of extension of the crawl 3 (in certain embodiments parallel to the moving direction) by an actuator (which is not shown in the accompanying figure), to keep the respective crawl 4 stretched in any configuration assumed by the remaining wheels 3 of the wheel assembly 3.

With reference to FIG. 1, the crawled vehicle 1 comprises a control assembly 5; a cabin 6; a user interface 7 arranged in the cabin 6; a shovel 8, which is supported by the frame 2 on the front side; a cutter 9, which is supported by the frame 2 on the rear side; a winch assembly 10, which is fixed above the frame 2; an internal combustion engine 11; and a powertrain 12, which is operatively connected to the internal combustion engine 11; to the driving wheels 3b; to the shovel 8; to the cutter 9; and to the winch assembly 10. In different embodiments, the powertrain 12 can be hydraulic or electric or a combination of hydraulic and electric.

The configurations of the crawls 4 depend on the configurations of the respective wheel assemblies 3. In particular, each wheel assembly 3 can be adjusted between different configurations, so as to adjust a crawl portion in contact with the snow surface M.

The central wheels 3c of each wheel assembly 3 are coupled two-by-two to respective supporting devices 15, which, in turn, are connected to the frame 2 in a movable manner.

For each supporting device 15, the crawled vehicle 1 comprises a shock absorber assembly 160 with a variable configuration and a variable stiffness to connect the respective two central wheels 3c, in particular through the supporting devices 15, to the frame 2, absorb possible hits and selectively change the position between the central wheels 3c and the frame 2. In other words, each supporting device 15 is connected to the frame through a respective shock absorber assembly 160. In particular, the shock absorber assembly 160 has a variable stiffness and a variable geometry, so as to change the reaction of the shock absorber assembly 160 to hits and be able to change the position of the crawled vehicle relative to the snow and of the crawl portion in contact with the snow.

In certain non-limiting examples of the present disclosure discussed herein, the crawled vehicle 1 comprises a supporting device 15 for each pair of central wheels 3c of the wheel assembly 3. In other words, each supporting device 15 is coupled to two central wheels 3c of the wheel assembly 3; as a consequence, for each wheel assembly 3, the crawled vehicle 1 comprises two supporting devices 15. Each supporting device 15 is coupled to two central wheels 3c.

Furthermore, each supporting device 15 couples the respective two central wheels 3c of the wheel assembly 3 to the frame 2 in an articulated manner, so as to couple said at least two central wheels 3c of the wheel assembly 3 to the frame 2.

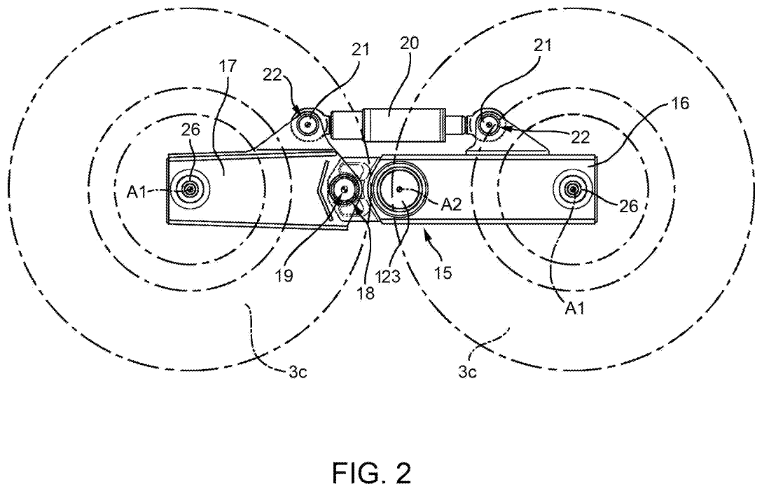

With reference to FIG. 2, the supporting device 15 has a first supporting element 16, which supports one of the two central wheels 3c; and a second supporting element 17, which supports another one of the two central wheels 3c; wherein the first supporting element 16 and the second supporting element 17 are connected to one another through a first articulated joint 18 in a first point 19. In certain embodiments, the first articulated joint 18 is a hinge.

Furthermore, the first and the second supporting element 16 and 17 are connected to one another through a shock absorber 20, in particular in points 21 that are different from the point 19. In more detail, the supporting device 15 comprises the shock absorber 20, which is connected to the first and to the second element by articulated joints 22 placed in the points 21, in particular two articulated joints 22 in the two points 21. In certain embodiments, the articulated joints 22 are hinges.

In certain embodiments, the shock absorber 20 has a variable stiffness.

In another embodiment, the shock absorber 20 has a variable geometry.

In another embodiment, the shock absorber 20 has a variable stiffness and a variable geometry.

In different embodiments, the shock absorber 20 is mechanical and/or hydraulic and/or electromagnetic and/or an air suspension or any combination thereof.

In more detail, the supporting device 15 comprises a connection articulated joint 123, which is partly housed on the first supporting element 16 and is coupled to the frame 2 so as to couple the supporting device 15 to the frame 2 in an articulated manner. In certain embodiments, the articulated joint 123 is a hinge.

The central wheels 3c are supporting wheels, in particular they are free rotating wheels. Furthermore, the central wheels 3c are middle wheels, which are placed between the front wheel 3a and the rear wheel 3b.

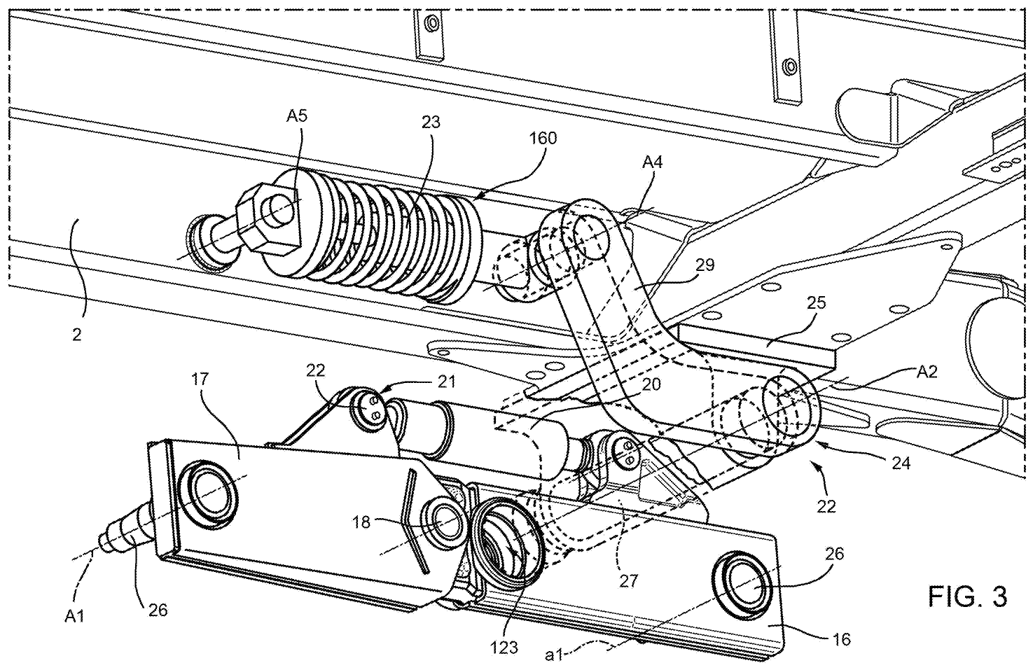

With reference to FIG. 3, each shock absorber assembly 160 comprises a mechanical connection arranged between the frame 2 and the supporting device 15. The mechanical connection comprises a double-acting hydraulic cylinder 23, a crank 24 and a plate 25 supporting the crank 24. The support device 15 comprises two attachments 26 for the two respective central wheels 3c around two rotation axes A1, which are transverse to the axis A (FIG. 1). The crank 24 comprises a shaft 27 with axis A2, which is parallel to the axes A1 and is mounted so as to rotate around the axis A2 in the support plate 25 fixed to the frame 2; an arm 29, which is integral to the shaft 27 and is mounted so as to rotate, at an end of the hydraulic cylinder 23, around an axis A4, which is parallel to the axes A1.

The hydraulic cylinder 23 has a first end fixed to the frame 2 so as to rotate around an axis A5, which is parallel to the axes A1. In this way, by changing the length of the hydraulic cylinder 23, it is possible to change the distance of the supporting device 15 from the frame 2 or, even better, the distance of the axis A2 from the frame 2, because the supporting device 15 can freely oscillate around the axis A2 and, hence, change the position of the respective central wheels 3 relative to the frame 2.

The control assembly 5 comprises a control unit 13 and the user interface 7 and has the function of acquiring a signal indicating an operating state of the crawled vehicle 1 as a function of at least one operating parameter of the crawled vehicle and, in certain embodiments, of a plurality of operating parameters, as well as the function of adjusting the configurations of the wheel assemblies 3 as a function of the signal indicating the operating state, in particular the function of adjusting the configuration and/or the stiffness of the shock absorber assemblies 160.

In certain non-limiting embodiments of the present disclosure, the control units 13, through the signal indicating the operating state, controls the shock absorbers 20 one-by-one or jointly.

In particular, through a manual mode, the driver controls both the position and the stiffness of the shock absorber assembly 160 and/or of each shock absorber or of all shock absorbers 20 through the support of the displaying on the user interface 7.

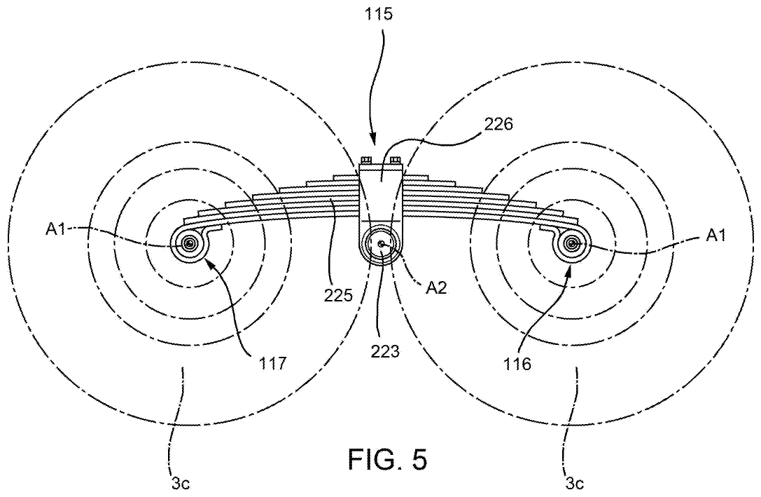

In an alternative embodiment of the present disclosure and with reference to FIG. 5, the supporting device 15 is replaced by a supporting device 115. The supporting device 115 comprises an elastic structure 225, in particular a leaf spring, as well as a first supporting element 116 and a second supporting element 117, which are arranged at respective ends of the elastic structure 225, in particular of the leaf spring, where two respective central wheels 3c are connected and supported. In the embodiment of FIG. 5, the ends of the spring leas 225 define the first and the second supporting element 116 and 117. In alternative embodiments, the elastic structure is defined by a fibreglass structure or a carbon structure comprising, at the respective ends, two supporting elements, which are connected to two respective central wheels 3c.

Furthermore, the supporting device 115, similarly to the supporting device 15, comprises a connection articulated joint 223, which is connected to the elastic structure 225 by a connection element 226. The connection articulated joint 223 is coupled to the frame 2 so as to couple the supporting device 115 to the frame 2 in an articulated manner. In certain embodiments, the articulated joint 223 is a hinge. In this embodiment, the elastic structure 225 enables the central wheels 3c to make movements in the range of 60 mm around the balance position, and, in certain embodiments, 20 mm around the balance position.

It should be appreciated that the present disclosure also covers embodiments that are not described in the detailed description above as well as equivalent embodiments that are part of the scope of protection set forth in the appended claims. Accordingly, various changes and modifications to the presently disclosed embodiments will be apparent to those skilled in the art.

The invention claimed is:

1-15. (canceled)

16. A crawled vehicle comprising:
a frame;
a first wheel assembly at a first side of the frame;
a first crawl wound around the first wheel assembly;
a second wheel assembly at a second, opposite side of the frame;
a second crawl wound around the second wheel assembly; and
at least one supporting device for each wheel assembly, wherein:
for each wheel assembly, the at least one supporting device is coupled to at least two wheels of that wheel assembly and articulately jointedly connected to the frame to couple the at least two wheels of that wheel assembly to the frame, and
for each wheel assembly, the at least one supporting device has a first supporting element which supports one of the at least two wheels of that wheel assembly and a second supporting element which supports another one of the at least two wheels of that wheel assembly such that the first supporting element and the second supporting element are one of: elastically flexibly connected and connected through a first articulated hinged joint at a first point.

17. The crawled vehicle of claim 16, wherein for each wheel assembly, the first supporting element and the second supporting element are connected through an elastic structure comprising one of: a leaf spring, a fiberglass structure, and a carbon structure.

18. The crawled vehicle of claim 16, wherein for each wheel assembly:
the at least one supporting device for that wheel assembly comprises an elastic structure comprising one of: a leaf spring, a fiberglass structure, and a carbon structure, and
the first supporting element and the second supporting element are defined by one of: a portion of the one of the leaf spring, a portion of the fiberglass structure, a portion of the carbon structure, an end of the leaf spring, an end of the fiberglass structure, and an end of the carbon structure.

19. The crawled vehicle of claim 16, further comprising, for the at least one supporting device of each wheel assembly, at least a second articulated hinged joint that articulately jointedly couples the first supporting element with the second supporting element.

20. The crawled vehicle of claim 16, wherein for the at least one supporting device of each wheel assembly, the first supporting element and the second supporting element are connected through a shock absorber at least a second point different from the first point.

21. The crawled vehicle of claim 20, wherein the shock absorber comprises at least one of: a variable stiffness and a variable geometry.

22. The crawled vehicle of claim 20, wherein the shock absorber is at least one of: a mechanic type, a hydraulic type, an electromagnetic type and an air suspension type.

23. The crawled vehicle of claim 16, wherein for each wheel assembly, the at least one supporting device of that wheel assembly comprises a connection articulated hinged joint coupled to the frame to couple the at least one supporting device to the frame.

24. The crawled vehicle of claim 16, wherein for each wheel assembly, the at least two wheels of that wheel assembly are freely rotatable supporting wheels.

25. The crawled vehicle of claim 16, wherein each wheel assembly comprises a driving wheel.

26. The crawled vehicle of claim 16, wherein each wheel assembly comprises a regulating crawl wheel having a mobile position relative to the frame and configured to stretch the crawl wound around that wheel assembly.

27. The crawled vehicle of claim 26, wherein for each wheel assembly, the at least two wheels of that wheel assembly are freely rotatable middle supporting wheels between the regulating crawl wheel and a driving wheel.

28. The crawled vehicle of claim 16, wherein for each wheel assembly, the at least one supporting device of that wheel assembly is connected to the frame through a shock absorber assembly.

29. The crawled vehicle of claim 28, wherein the shock absorber assembly has at least one of: a variable stiffness and a variable geometry.

30. The crawled vehicle of claim 29, wherein the shock absorber assembly comprises a double effect type of hydraulic cylinder.

31. The crawled vehicle of claim 16, wherein each wheel assembly comprises a regulating crawl wheel, a driving wheel, two couples of supporting wheels and two supporting devices respectively coupled to the two couples of supporting wheels.

32. A crawled vehicle wheel assembly comprising:
at least two wheels; and
at least one supporting device coupled to the at least two wheels and configured to be articulately jointedly connected to a frame of a crawled vehicle to couple the at least two wheels to the frame, wherein the at least one supporting device comprises:
a first supporting element which supports one of the at least two wheels, and
a second supporting element which supports another one of the at least two wheels such that the first supporting element and the second supporting element are one of: elastically flexibly connected and connected through a first articulated hinged joint at a first point.
